(19) United States
(12) Patent Application Publication
(10) Pub. No.: US 2016/0050569 A1
(43) Pub. Date: Feb. 18, 2016

(54) METHOD FOR TESTING IMPLICIT BEAMFORMING PERFORMANCE OF A MULTIPLE-INPUT MULTIPLE-OUTPUT RADIO FREQUENCY DATA PACKET SIGNAL TRANSCEIVER

(71) Applicant: LITEPOINT CORPORATION, Sunnyvale, CA (US)

(72) Inventors: Christian Volf Olgaard, Saratoga, CA (US); Roman Schilter, Sunnyvale, CA (US); Guang Shi, San Jose, CA (US)

(21) Appl. No.: 14/795,390

(22) Filed: Jul. 9, 2015

Related U.S. Application Data
(63) Continuation-in-part of application No. 14/461,573, filed on Aug. 18, 2014, now abandoned.

(51) Int. Cl. H04W 24/02; H04L 29/06; H04B 7/04

(52) U.S. Cl. CPC H04W 24/02; H04B 7/0413; H04L 69/22

(57) ABSTRACT

Method for testing implicit beamforming performance of a multiple-input multiple-output (MIMO) radio frequency (RF) data packet signal transceiver device under test (DUT). The data packet signals forming the sequential data packet signal transmissions used for beamforming are produced with a selectively varied phase difference and conveyed via internal RF signal paths to external transmit terminals. Combining these transmitted data packet signals produces a combined data packet signal in which a peak power occurs during which a particular phase difference is being induced between the sequential DUT data packet signal transmissions used for the beamforming. This phase difference corresponds to the difference in RF signal phase lengths between the internal RF signal paths of the DUT, and is thereby indicative of the amount of phase shift needed between the sequential DUT data packet signal transmissions used for the beamforming to enable optimal implicit beamforming performance.

### BACKGROUND

The present invention relates to testing a radio frequency (RF) data packet signal transceiver device under test (DUT), and in particular, testing implicit beamforming performance of a multiple-input multiple-output (MIMO) DUT.

Many of today's electronic devices use wireless technologies for both connectivity and communications purposes. Because wireless devices transmit and receive electromagnetic energy, and because two or more wireless devices have the potential of interfering with the operations of one another by virtue of their signal frequencies and power spectral densities, these devices and their wireless technologies must adhere to various wireless technology standard specifications.

When designing such wireless devices, engineers take extra care to ensure that such devices will meet or exceed each of their included wireless technology prescribed standard-based specifications. Furthermore, when these devices are later being manufactured in quantity, they are tested to ensure that manufacturing defects will not cause improper operation, including their adherence to the included wireless technology standard-based specifications.

For testing these devices following their manufacture and assembly, current wireless device test systems employ a subsystem for analyzing signals received from each device. Such subsystems typically include at least a RF data packet signal transmitter, such as a vector signal generator (VSG), for providing the source signals to be transmitted to the device under test, and a RF data packet signal receiver, such as a vector signal analyzer (VSA), for receiving and analyzing signals produced by the DUT. The production of test signals by the VSG and signal analysis performed by the VSA are generally programmable so as to allow each to be used for testing a variety of devices for adherence to a variety of wireless technology standards with differing frequency ranges, bandwidths and signal modulation characteristics.

Multiple-input multiple-output (MIMO) technology (multiple input, or receive, signal paths and multiple output, or transmit, signal paths) has been adopted for use in accordance with signal standards, including standards as IEEE 802.11n and IEEE 802.11ac, and cellular telephone signal standards, including LTE and LTE Advanced. Devices using MIMO technology rely upon beamforming to maximize received signal strength and minimize signal errors. In testing devices that employ MIMO technology, it must be determined whether the beamforming method being applied (e.g., explicit or implicit) is performing in accordance with the applicable signal standard.

Beamforming technology can increase the transmit (TX) signal range of a MIMO device by sending a packet using multiple antennas and adjusting the phase difference (or “delta”), and perhaps magnitude difference, between the MIMO data packet signals such that the signals arriving at a base station (or reference) antenna will benefit from the power enhancement of multipath constructive signal interference. (These adjustments can be made on a per subcarrier basis in the case of orthogonal frequency division multiplexed (OFDM) signals.) In a similar way, the receiving system the MIMO data packet signals can use multiple antennas to increase receive signal sensitivity.

Explicit beamforming involves an exchange of information between the device and base station (or tester when operating in a test environment, and often referred to as a “reference”) to exchange information about the wireless signal path, or channel, within which they are communicating. Such information is used to determine the phase difference(s) to apply to outgoing transmit (TX) signals so as to optimize the power at each antenna receiving such TX signal resulting from multipath signal effects (e.g., constructive and destructive signal interferences).

Implicit beamforming involves no exchange of information about the signal channel. The premise is that the channel has reciprocity, or symmetry, such that the characteristics of the channel are the same for both systems that are communicating (e.g. a handheld device and base station). Accordingly, a device attempts to derive a channel model based on signals it receives from a reference, from which it calculates a signal steering matrix and applies signal phase differences to its outgoing TX signals so as to optimize the power at the receiving antenna of the reference resulting from multipath signal effects. The phase difference that is applied (e.g., as a phase offset) is based upon an assumption that the effective phase lengths of the respective TX and receive (RX) signal paths traveled by the MIMO signals within the device are equal between the TX circuitry from which the TX signal originates and the RX circuitry receiving the RX signal and their respective connections from and to the respective antennas.

Ideally, the phase lengths of the signal paths between the TX and RX integrated circuit I/O terminal(s) and any additional internal TX and RX subsystems, and between the antenna connections, or ports, and I/O pins would all be the same such that the corresponding mutual phase differences would be zero. However, it is typically much more likely that such phase differences among the signal paths will be non-zero, and perhaps significant (e.g., closer to 180 degrees, or it radians, than to zero degrees or radians). Hence, for beamforming to be effective, these inherent phase differences need to be compensated by calibration. For example, if the phase difference between two paths is 15 degrees, that phase difference must be used to calculate the actual phase difference to be applied by the device to impart proper beamforming via the antennas.

Implicit beamforming is more advantageous than explicit because it is less time consuming and complex. However, without the ability to easily calibrate device signal path phase differences, beamforming performance will be less than optimal. Accordingly, it would be desirable to have a method for calibrating a device using implicit beamforming, testing a device to ensure whether its implicit beamforming is performing properly, and verifying whether a calibration value provided with a device is, in fact, accurate.

### SUMMARY

In accordance with the presently claimed invention, a method is provided for testing implicit beamforming performance of a multiple-input multiple-output (MIMO) radio frequency (RF) data packet signal transceiver device under test (DUT). The data packet signals forming the sequential data packet signal transmissions used for beamforming are produced with a selectively varied phase difference and conveyed via internal RF signal paths to external transmit terminals. Combining these transmitted data packet signals produces a combined data packet signal in which a peak power occurs during which a particular phase difference is being induced between the sequential DUT data packet signal transmissions used for the beamforming. This phase difference corresponds to the difference in RF signal phase lengths between the internal RF signal paths of the DUT, and is thereby indicative of the amount of phase shift needed between the sequential DUT data packet signal transmissions used for the beamforming to enable optimal implicit beamforming performance.

In accordance with one embodiment of the presently claimed invention, a method for testing implicit beamforming performance of a multiple-input multiple-output (MIMO) radio frequency (RF) data packet signal transceiver device under test (DUT) includes:
receiving from the DUT a plurality of sequential DUT data packet signal transmissions including at least first and second contemporaneous sequences of DUT data packet signal transmissions with first and second mutually corresponding portions, respectively, having respective different nominal signal phase differences; and
combining at least the first and second contemporaneous sequences of DUT data packet signal transmissions to provide a combined sequential DUT data packet signal transmission.

In accordance with another embodiment of the presently claimed invention, a method for testing implicit beamforming performance of a multiple-input multiple-output (MIMO) radio frequency (RF) data packet signal transceiver device under test (DUT) includes:
generating, with the DUT, a plurality of sequential DUT data packet signal transmissions including at least first and second contemporaneous sequences of DUT data packet signal transmissions;
controlling a nominal signal phase of at least one of the first and second contemporaneous sequences of DUT data packet signal transmissions such that the first and second contemporaneous sequences of DUT data packet signal transmissions include first and second mutually corresponding portions, respectively, having respective different nominal signal phase differences; and
conveying at least the first and second mutually corresponding portions of the first and second contemporaneous sequences of DUT data packet signal transmissions via first and second RF signal paths within the DUT to provide first and second DUT transmit signals via first and second external DUT terminals, respectively.

### BRIEF DESCRIPTION OF THE DRAWINGS

FIG. 1 depicts a testing environment for testing implicit beamforming performance of a MIMO RF data packet signal transceiver in accordance with exemplary embodiments of the presently claimed invention.

FIG. 2 is a flowchart depicting a method for testing implicit beamforming in accordance with exemplary embodiments of the presently claimed invention.

FIG. 3 depicts reference and DUT data packet signal flows when testing implicit beamforming performance in accordance with exemplary embodiments of the presently claimed invention.

FIG. 4 depicts reference and DUT data packet signal flows when testing implicit beamforming performance in accordance with further exemplary embodiments of the presently claimed invention.

FIG. 5 depicts transmission of a single data packet with varying data symbol contents for testing implicit beamforming performance in accordance with exemplary embodiments of the presently claimed invention.

FIG. 6 depicts exemplary signal paths within a DUT for which implicit beamforming performance can improve performance in accordance with exemplary embodiments of the presently claimed invention.

FIG. 7 depicts simplified examples of constructive and destructive signal interferences associated with multipath signal effects.

FIG. 8 depicts power and gain variations for a beamformed signal over a range of applied phase offsets in accordance with exemplary embodiments of the presently claimed invention.

### DETAILED DESCRIPTION

The following detailed description is of example embodiments of the presently claimed invention with references to the accompanying drawings. Such description is intended to be illustrative and not limiting with respect to the scope of the present invention. Such embodiments are described in sufficient detail to enable one of ordinary skill in the art to practice the subject invention, and it will be understood that other embodiments may be practiced with some variations without departing from the spirit or scope of the subject invention.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide the described function. Additionally, the term “signal” may refer to one or more currents, one or more voltages, or a data signal. Within the drawings, like or related elements will have like or related alpha, numeric or alphanumeric designators. Further, while the present invention has been discussed in the context of implementations using discrete electronic circuitry (preferably in the form of one or more integrated circuit chips), the functions of any part of such circuitry may alternatively be implemented using one or more appropriately programmed processors, depending upon the signal frequencies or data rates to be processed. Moreover, to the extent that the figures illustrate diagrams of the functional blocks of various embodiments, the functional blocks are not necessarily indicative of the division between hardware circuitry.

As discussed in more detail below, in accordance with exemplary embodiments of the presently claimed invention, a reference data packet received by a DUT from a reference (e.g., a tester, as discussed above) is used to establish an initial phase difference between two MIMO data packet signals being transmitted by the DUT. This initial phase difference is applied (e.g., by adding a corresponding phase shift to one of the signals) and a MIMO signal steering matrix is computed for transmitting data packets. The resulting beamformed transmitted data packet signals with this added phase difference are received by the reference, which measures and records the power of the resulting received signal, including multipath effects due to the use of MIMO signals. Further data packet signals continue to be transmitted by the DUT, with further phase differences applied (e.g., incremented or decremented in accordance with a predetermined sequence). The reference receives these data packets with the series of phase differences, and measures and records a received signal power resulting from multipath signal effects. This continues until the applied phase difference reaches a predetermined upper limit value (e.g., 360 degrees or 2π radians, for a total phase difference range of zero through 2π radians). The resulting measured and recorded power measurements can be used to identify the phase difference producing the highest received signal power. The corresponding phase difference producing such highest measured received signal power will be related (e.g., equal) to the optimal phase calibration value for the DUT.

This technique in which the peak power level is identified to then further identify its corresponding phase difference is more likely preferred when measuring power in a linear domain (e.g., watts). Alternatively, when measuring power in a logarithmic domain (e.g., decibels), the two minimum power levels can be identified to then further identify their corresponding phase differences, with the phase difference at the midpoint between them corresponding to the phase offset related (e.g., equal) to the optimal phase calibration value for the DUT.

Such optimal phase calibration values are determined for each signal path, or channel, within the DUT, and then used as respective static base phase offsets within the signal paths. Later, during normal operation of the DUT, any further signal phase adjustments for performing beamforming are applied in addition to, or on top of, these static base phase offsets.

Hence, the DUT produces data packet signals with mutual phase differences swept across a predetermined range (e.g., 0-27π radians) to produce a received data packet signal having a power level with varying magnitudes correlated to the phase differences and having a peak power magnitude. In those instances where the intended swept phase difference signals produce no difference in received signal power, it may be concluded that the implicit beamforming performed by the DUT is defective. Alternatively, in those instances where the mutual phase differences among the DUT signal paths are known, or specified, the measured signal powers, particularly the measured peak signal power, may be used to confirm whether such known or specified phase difference is accurate or inaccurate. Further, after the optimal phase calibration values have been determined and used to establish corresponding static base phase offsets within the signal paths, the beamforming performance of the DUT can be tested to confirm that, within the test environment, no additional phase offsets are needed for optimal performance.

The following discussion is in the context of a 2×2 MIMO DUT. However, as will be readily appreciated by one skilled in the art, the following testing methodology and techniques can be applied to N×N MIMO devices. For example, for a 3×3 MIMO device, signal paths 1 and 2 can be treated together as a 2×2 MIMO device, followed by then treating signal paths 2 and 3 together as another 2×2 MIMO device. More generally, for N×N MIMO devices, N−1 pairs of signal paths can be treated together as respective 2×2 MIMO devices to test and measure all combinations of implicit beamforming performances for the N×N MIMO device.

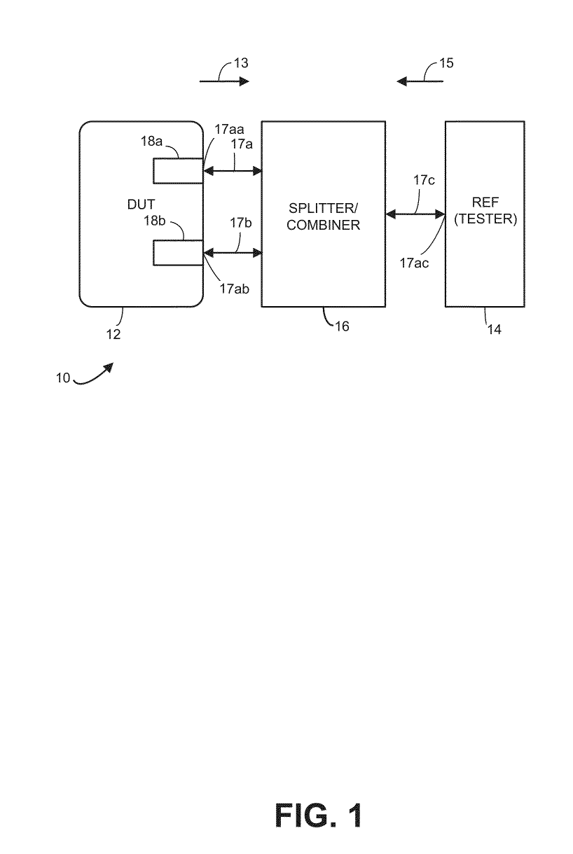

Referring to FIG. 1, in accordance with exemplary embodiments, a testing environment 10 includes (among other devices and subsystems not shown) the DUT 12, a reference (e.g., a tester, as discussed above) 14 and a signal router 16, such as a signal splitter and combiner, such as is well known in the art. The signal splitter/combiner 16 combines the DUT signals 13 conveyed via multiple signal paths 17a, 17b from the DUT 12 to a single signal for conveyance via a single signal path 17c for reception by the reference 14. In the other direction, the signal 15 provided by the reference 14 is split to provide multiple signals for conveyance via the multiple signal paths 17a, 17b to the DUT 12. These signal paths 17a 17b, 17c in the testing environment 10, are typically conductive signal paths (e.g., coaxial RF cables and connectors), such as are well known in the art.

Within the DUT 12, two signal paths 18a, 18b (or “chains”) include the various electronic devices, subsystems and conductive signal paths within the DUT 12 for producing (e.g., generating, amplifying, frequency converting, filtering, etc.) and conveying the RF signals provided by the DUT 12 for reception by the reference 14. (As noted above, a N×N DUT will have N signal paths 18a, 18b, . . . , 18n.) As discussed in more detail below, and as readily understood by those skilled in the art, these signal paths 18a, 18b, have signal path phase lengths that are determined by the circuit devices and signal conductors in various integrated circuits (ICs) and between various input/output (I/O) electrodes and the external signal connectors 17aa, 17ab used for conveying the signals to and from antennas (not shown) during normal operation of the DUT 12 outside of the testing environment 10.

As discussed above, differences in these signal path phase lengths can cause a non-zero phase difference between these two signal paths 18a, 18b. By applying beamforming, a phase difference between the signals emitted by the DUT 12 can be applied to ensure that optimum constructive multipath signal interference occurs at the receiving antenna of the reference 14.

It will be appreciated that use of a power combiner 16 virtually ensures that signal phase differences attributable to the TX and RX signal paths within the tester 14 can effectively be ignored as incoming (to the tester) signals are already combined before entering the tester 14 via the signal path 17c.

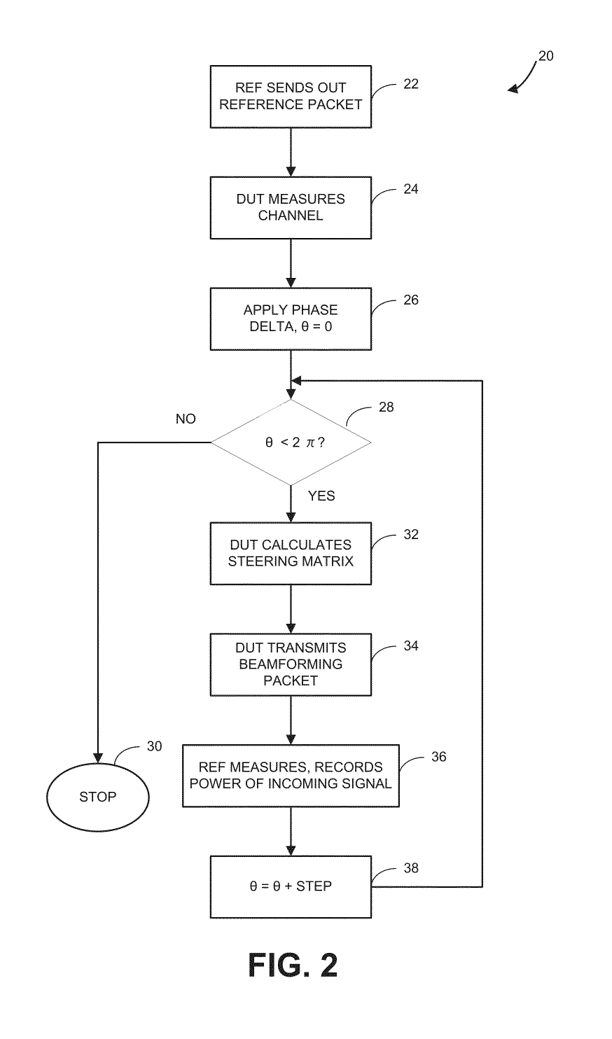

Referring to FIG. 2, the applied phase shift, or difference, as discussed above, is initiated by the reference 14 sending out a reference data packet 22. The DUT 12 measures the received channel characteristics 24 (e.g., by measuring the phase difference between the two signals received via the two signal paths 18a, 18b). Beginning with an initial added phase difference (e.g., of 0 degrees/radians) 26, such phase difference is checked 28 to see if it is less than 2π radians. If it is, based upon the inherent phase offset θ, the DUT 12 calculates a signal steering matrix 32 (which includes effects of the receive signal path portions of the two signal paths 18a, 18b), e.g., as follows:

R=H1*T1+H2*T2

(where R=signal received at reference antenna, TN=signal transmitted via DUT output N, and HN=signal steering matrix coefficient corresponding to signal path between DUT output N and reference antenna)

Using this steering matrix, the DUT 12 then transmits a data packet with beamforming applied 34. The reference 14 receives this data packet 36, and measures and records the power of the incoming, or received, signal. The applied phase difference θ is then incremented, or decremented, 38, following which the applied phase difference θ is again checked 28 to see if it has yet exceeded the upper limit (e.g., 2π radians). If it has exceeded this maximum value, operation is stopped 30. Otherwise, operation continues 32, 34, 36, 38, including re-calculating the signal steering matrix 32 to account for the revised (e.g., incremented or decremented) applied phase offset θ.

In the case of a 2×2 DUT, the phase offset θ is added and varied for a single pair of RF signal paths 18a, 18b (FIG. 1) as discussed above. In the case of a N×N DUT, multiple phase offsets θ1, θ2, θ3, . . . are preferably added and varied for respective pairs of the multiple RF signal paths 18a, 18b, . . . , 18n (which are all active for MIMO operation), and can be done for various combinations of RF signal paths. For example, in the case of a 3×3 DUT, phase offsets θ1, θ2, θ3 can be added and varied for respective pairs (18a and 18b), (18a and 18c), (18b and 18c) of the three RF signal paths. Additionally, the phase offsets θ1, θ2, θ3 can be can be added and varied on a packet-by-packet basis in a round robin fashion, e.g., as follows:
Packet 1: TXa=a, TXb=b, TXc=c
Packet 2: TXa=a, TXb=b+θ2, TXc=c
Packet 3: TXa=a, TXb=b, TXc=c+θ3
Packet 4: TXa=a, TXb=b+θ2, TXc=c+θ3

and so on, where TXm=m indicates DUT transmit signal m conveyed via RF signal path m with zero phase offset added, and TXm=m+θm indicates DUT transmit signal m conveyed via RF signal path m with phase offset θm added.

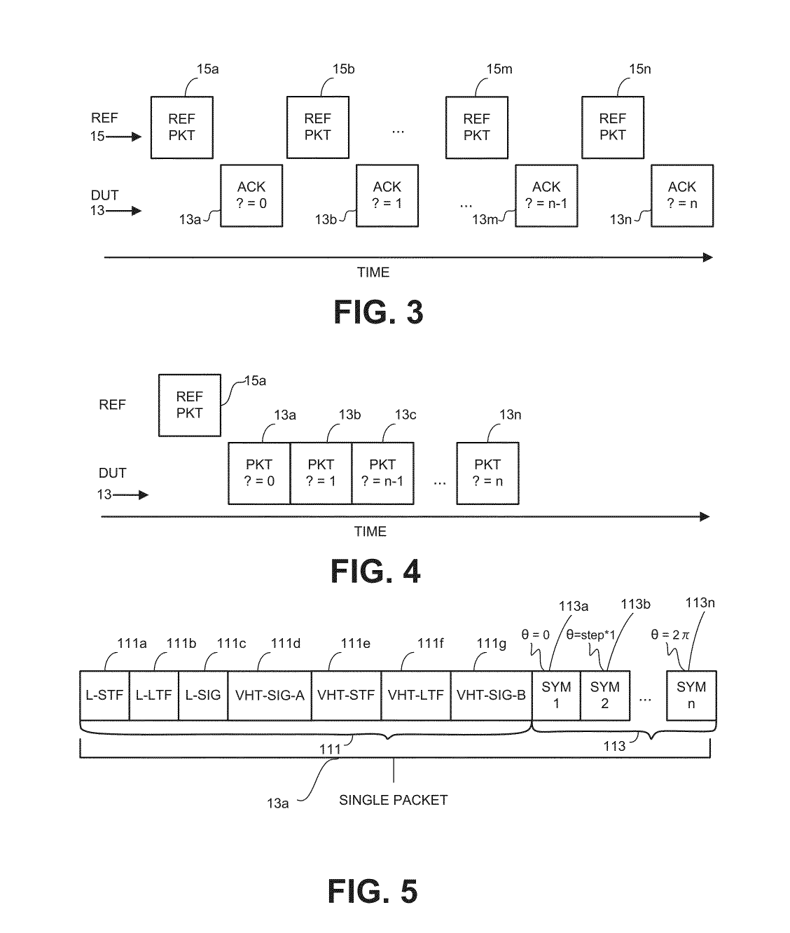

Referring to FIG. 3, in accordance with exemplary embodiments, the reference 14 transmits a series of reference data packets, 15a, 15b, . . . , 15m, 15n. In response to each one of these reference data packets 15, the DUT 12 transmits a responsive (e.g., acknowledgement ACK) data packet 13a, 13b, . . . , 13m, 13n. Each one of these successive data packets 13 has a different predetermined incremented (or decremented) phase difference (e.g., as a fraction of 360 degrees or 2π radians) applied between the two signals being transmitted via the antenna connections 17aa, 17ab.

Referring to FIG. 4, in accordance with alternative exemplary embodiments, this implicit beamforming operation for testing can be initiated by a single reference data packet 15a. In response to this data packet 15a, the DUT transmits successive pre-programmed data packets 13a, 13b, 13c, . . . , 13n having successively incremented (or decremented) phase differences applied between the two data packet signals being transmitted.

Referring to FIG. 5, in accordance with alternative exemplary embodiments, the individual data packets 13a can include a mixed mode data packet structure having multiple segments 111 followed by multiple symbols 113. The respective symbols 113a, 113b, . . . , 113n can include successively incremented (or decremented) added signal phases, as discussed above.

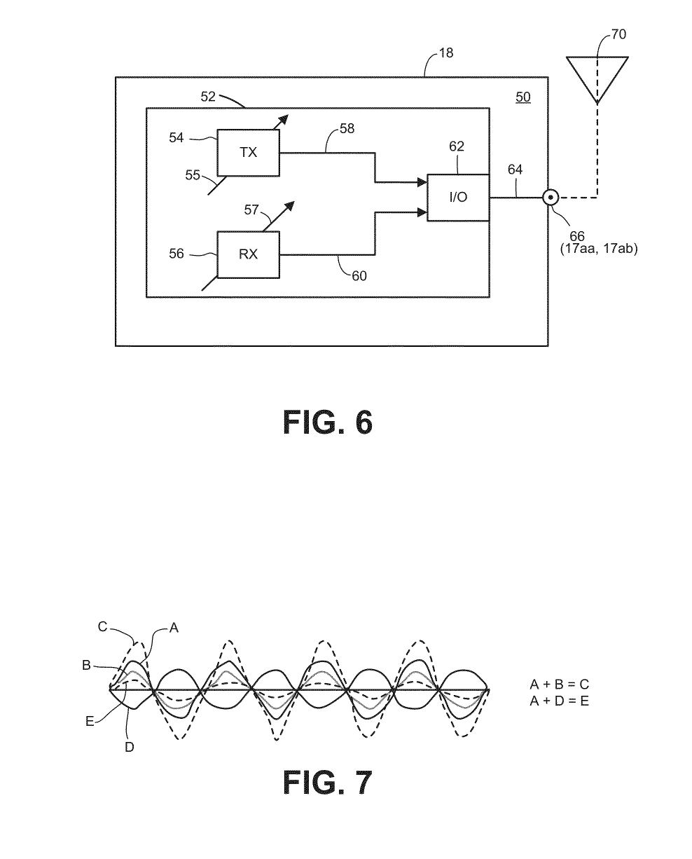

Referring to FIG. 6, as discussed above, the signal paths 18 (FIG. 1) through which various signal phase shifts can be imparted include multiple elements, or components, each of which can affect the phase shift. For example, within each signal path 18, a circuit assembly 50 includes one or more integrated circuits 52, having TX circuitry 54 (e.g., baseband and RF conversion/amplifier circuitry, any or all of which may include variable signal gain and/or phase 55), RX circuitry 56 (e.g., baseband and RF signal conversion/amplifier circuitry, any or all of which may include variable signal gain and/or phase 57), and one or more I/O circuitry 62 (e.g., one or more signal electrodes), interconnected by conductive signal paths 58, 60, as shown. Signal routing circuits or devices (e.g., switches, combiners, splitters, diplexors and isolation circuits) may also be included as part of one or more of the TX circuitry 54, RX circuitry 56 or I/O circuitry 62. A further signal connection 64 is provided between the I/O terminal(s) 62 and the antenna terminal 66 to which an antenna 70 is connected during normal operation of the DUT 12 outside of the testing environment 10. As will be readily appreciated by one skilled in the art, the cumulative phase shift imparted to a signal provided via the TX signal path 54, 58, 62 and received by the RX signal path 62, 60, 56 will vary from one device to another. Accordingly, determining one or more appropriate controlled phase offsets 55, 57 in accordance with the discussion above can render the phase shift in any given signal path 18 such that a minimal (ideally, zero) phase difference can be maintained between related TX and RX signal paths within the DUT 12.

Referring to FIG. 7, a simple example of constructive and destructive multipath signal effects for single frequency, fixed phase signals occurs as shown. For example, in the case of a signals arriving with zero signal phase difference, such as signals A and B, the resulting signal C has a maximum signal magnitude at the point of reception (e.g., receiving antenna). Conversely, if these signals arrive with opposite signal phases, such as signals A and D, destructive signal interference occurs, thereby producing a reduced signal magnitude E.

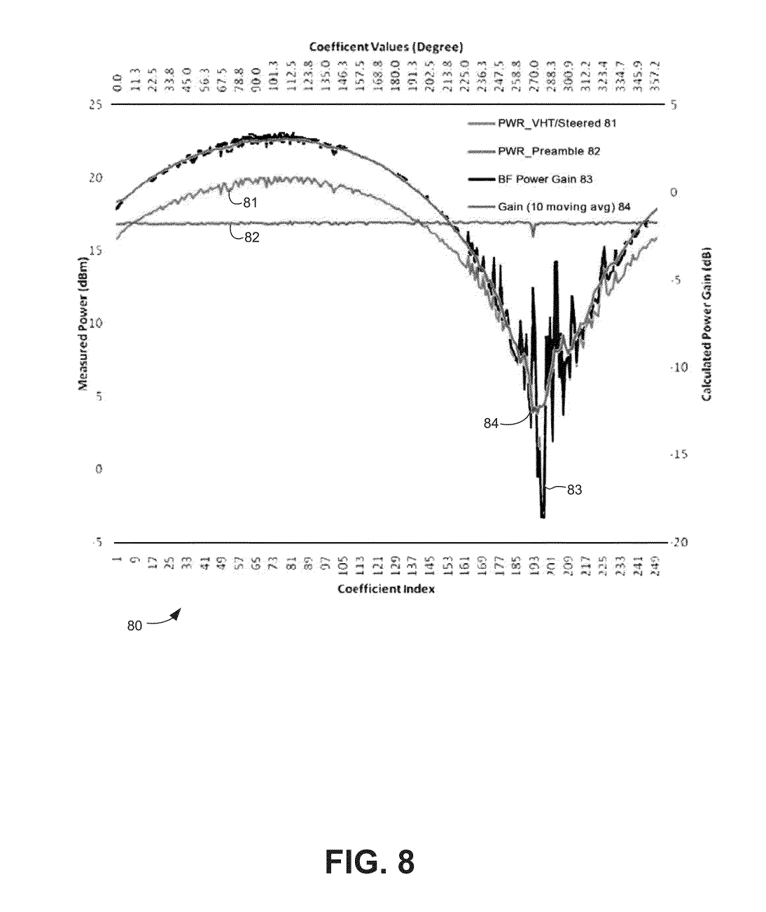

Referring to FIG. 8, exemplary power and gain variations of a beamformed signal over a range of 0-360 degrees (0-27π radians) of applied phase offsets (horizontal axis) can be expected as shown when power (vertical axis) is plotted on a logarithmic scale. If plotted on a linear scale, the power variations would appear in sinusoidal form.

Various other modifications and alterations in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method for testing implicit beamforming performance of a multiple-input multiple-output (MIMO) radio frequency (RF) data packet signal transceiver device under test (DUT), comprising:
transmitting, with a reference RF signal source, at least one source data packet signal transmission;
receiving from said DUT a plurality of sequential DUT data packet signal transmissions including at least first and second contemporaneous sequences of DUT data packet signal transmissions with first and second mutually corresponding portions, respectively, having respective different nominal signal phase differences related to said at least one source data packet signal transmission;
combining at least said first and second contemporaneous sequences of DUT data packet signal transmissions to provide a combined sequential DUT data packet signal transmission; and
repeating said transmitting, receiving and combining, wherein said respective different nominal signal phase differences comprise successively different nominal signal phase differences.

2. The method of claim 1, wherein respective ones of said first and second mutually corresponding portions have identical data packet contents.

3. The method of claim 1, wherein said combined sequential DUT data packet signal transmission includes a peak power corresponding to a portion of a combination of said first and second mutually corresponding portions of said first and second contemporaneous sequences of DUT data packet signal transmissions.

4. The method of claim 1, wherein said respective different nominal signal phase differences comprise successively incremented nominal signal phase differences.

5. The method of claim 1, wherein said respective different nominal signal phase differences comprise successively decremented nominal signal phase differences.

6. The method of claim 1, wherein said plurality of sequential DUT data packet signal transmissions is responsive to said at least one source data packet signal transmission.

7. The method of claim 1, further comprising measuring a power level of each one of a plurality of portions of said combined sequential DUT data packet signal transmission.

8. The method of claim 1, wherein said each one of a plurality of portions of said combined sequential DUT data packet signal transmission corresponds to a respective portion of a combination of said first and second mutually corresponding portions of said first and second contemporaneous sequences of DUT data packet signal transmissions.

9. The method of claim 1, further comprising performing said transmitting, receiving, combining and repeating for multiple respective pairs of a plurality of RF signal paths within said DUT.

10. The method of claim 9, further comprising, for one or more of said plurality of RF signal paths within said DUT, setting a static phase offset equal to a respective one of said different nominal signal phase differences.

11. The method of claim 9, further comprising, for one or more of said plurality of RF signal paths within said DUT:
setting a static phase offset equal to a respective one of said different nominal signal phase differences; and
performing said transmitting, receiving, combining and repeating for multiple respective pairs of said one or more of said plurality of RF signal paths within said DUT.

12. A method for testing implicit beamforming performance of a multiple-input multiple-output (MIMO) radio frequency (RF) data packet signal transceiver device under test (DUT), comprising:
receiving, with said DUT, at least one source data packet signal transmission;
generating, with said DUT, a plurality of sequential DUT data packet signal transmissions including at least first and second contemporaneous sequences of DUT data packet signal transmissions;
controlling a nominal signal phase of at least one of said first and second contemporaneous sequences of DUT data packet signal transmissions such that said first and second contemporaneous sequences of DUT data packet signal transmissions include first and second mutually corresponding portions, respectively, having respective different nominal signal phase differences related to said at least one source data packet signal transmission
conveying at least said first and second mutually corresponding portions of said first and second contemporaneous sequences of DUT data packet signal transmissions via first and second RF signal paths within said DUT to provide first and second DUT transmit signals via first and second external DUT terminals, respectively; and
repeating said receiving, generating, controlling and conveying, wherein said respective different nominal signal phase differences comprise successively different nominal signal phase differences.

13. The method of claim 12, wherein respective ones of said first and second mutually corresponding portions have identical data packet contents.

14. The method of claim 12, wherein said controlling a nominal signal phase of at least one of said first and second contemporaneous sequences of DUT data packet signal transmissions comprises successively incrementing said nominal signal phase difference.

15. The method of claim 12, wherein said controlling a nominal signal phase of at least one of said first and second contemporaneous sequences of DUT data packet signal transmissions comprises successively decrementing said nominal signal phase difference.

16. The method of claim 12, wherein said performing said generating, controlling and conveying subsequent to said receiving at least one source data packet signal transmission is responsive to said receiving at least one source data packet signal transmission.

17. The method of claim 12, further comprising combining said first and second DUT transmit signals.

18. The method of claim 12, further comprising performing said receiving, generating, controlling, conveying and repeating for multiple respective pairs of a plurality of RF signal paths within said DUT.

19. The method of claim 18, further comprising, for one or more of said plurality of RF signal paths within said DUT, setting a static phase offset equal to a respective one of said different nominal signal phase differences.

20. The method of claim 18, further comprising, for one or more of said plurality of RF signal paths within said DUT:
setting a static phase offset equal to a respective one of said different nominal signal phase differences; and
performing said receiving, generating, controlling, conveying and repeating for multiple respective pairs of said one or more of said plurality of RF signal paths within said DUT.
